(19) United States
(12) Patent Application Publication
(10) Pub. No.: US 2024/0422654 A1
(43) Pub. Date: Dec. 19, 2024

(54) SIGNALING FOR DISTRIBUTED NETWORK SENSING OPERATIONS

(71) Applicant: NOKIA TECHNOLOGIES OY, Espoo (FI)

(72) Inventors: Silvio MANDELLI, Stuttgart (DE); Ryan KEATING, Naperville, IL (US); Mark DOLL, Stuttgart (DE); Maximilian ARNOLD, Stuttgart (DE)

(21) Appl. No.: 18/694,881

(22) PCT Filed: Oct. 19, 2022
(86) PCT No.: PCT/EP2022/079024

§ 371 Date: Mar. 22, 2024

Related U.S. Application Data
(60) Provisional application No. 63/277,844, filed on Nov. 10, 2021.

(51) Int. Cl. H04W 48/16; H04W 88/08

(52) U.S. Cl. CPC H04W 48/16; H04W 88/08

(57) ABSTRACT

In some example embodiments, there may be provided a method that includes determining, by a managing entity, a plurality of sensing access points to enable a scan of an area; and providing, by the managing entity, a first request to a first sensing access point to receive at least one probing signal transmitted by a second sensing access point, wherein the request shares configuration information about the at least one probing signal transmitted by the second sensing access point to enable configuration of at least the first sensing access point for reception of the transmitted at least one probing signal. Related systems, methods, and articles of manufacture are also disclosed.

### FIELD

The subject matter described herein relates to wireless communications.

### BACKGROUND

With the 5^{th} generation (5G) of mobile communication, the network is being driven with respect to latency, throughput, and spectral efficiency. With the advent of the 6^{th} generation (6G) and beyond, the network may be pushed even further, so there is a need to facilitate gains in network performance.

### SUMMARY

In some example embodiments, there may be provided a method that includes determining, by a managing entity, a plurality of sensing access points to enable a scan of an area; and providing, by the managing entity, a first request to a first sensing access point to receive at least one probing signal transmitted by a second sensing access point, wherein the request shares configuration information about the at least one probing signal transmitted by the second sensing access point to enable configuration of at least the first sensing access point for reception of the transmitted at least one probing signal.

In some variations, one or more of the features disclosed herein including the following features can optionally be included in any feasible combination. The managing entity may receive at least one scan measurement obtained from the at least one probing signal received by the first sensing access point to provide information about the area. The managing entity may provide a second request to the second sensing access point to transmit the at least one probing signal, wherein the second request includes the configuration information to configure at least the second sensing access point to transmit the at least one probing signal. The configuration information may include one or more of the following: a frame number, a subframe number, transmit beam direction information, a direction, a beamwidth, a beam identifier, one or more resource elements carrying the at least one probing signal, a bandwidth, a burst size, a period, and a start time indicating a transmission time of the at least one probing signal. Each of the plurality of sensing access points may comprise or be comprised in at least one of a base station, a gNB, a distributed unit, a radio unit, or a transmit receive point. The managing entity may comprise or be comprised in at least one of a location management function or a sensing access point. The at least one probing signal may include a sensing signal and/or a position reference signal. The determining may include determining at least the first sensing access point to receive the at least one probing signal and determining at least the second sensing access point to transmit the at least one probing signal. The at least one scan measurement may provide information about the area, wherein the at least one scan measurement provides, for each object sensed and/or channel path carrying the at least one probing signal, one or more measurements with respect to one or more of the following: a beamwidth, a beam direction, a range, a time of arrival, an angle of arrival, a velocity, a Doppler value, a set of one or more complex coefficients, and a channel estimate for the channel path carrying the at least one probing signal. The managing entity may determine the configuration information based on a quality of service with respect to accuracy and/or resolution. The at least one scan measurement may include a scan identifier to identify the at least one scan measurement obtained from the at least one probing signal from other scan measurements performed on other probing signals. The managing entity may provide a plurality of first requests to a plurality of first sensing access points to receive a plurality of probing signals transmitted by a plurality of second sensing access points, wherein the managing entity receives a plurality of scan measurements obtained from the plurality of probing signals received by the plurality of first sensing access points. Moreover, the method may further include determining configuration information to enable the scan and determining, based at least on the at least one scan measurement, updated configuration information to enable an updated scan of at least a portion of the area. The first sensing access point and the second sensing access point may comprise or be comprised in the same sensing access point.

In some example embodiments, there may be provided a method that includes receiving, by a first sensing access point, a first request to receive at least one probing signal transmitted by a second sensing access point to enable a scan of an area, wherein the request shares configuration information about the at least one probing signal transmitted by the second sensing access point, the shared configuration information enabling configuration of the first sensing access point for reception of the transmitted at least one probing signal.

In some variations, one or more of the features disclosed herein including the following features can optionally be included in any feasible combination. The first sensing access point may send at least one scan measurement to a managing entity to provide information about the area to enable aggregation of the at least one scan measurement with other scan measurements from other sensing access points, wherein the at least one scan measurement is obtained from the at least one probing signal received by the first sensing access point. The configuration information may include one or more of the following: a frame number, a subframe number, transmit beam direction information, a direction, a beamwidth, a beam identifier, one or more resource elements carrying the at least one probing signal, a bandwidth, a burst size, a period, and a start time indicating a transmission time of the at least one probing signal. Each of the first sensing access point and the second sensing access point may comprise or be comprised in at least one of a base station, a gNB, a distributed unit, a radio unit, or a transmit receive point. The managing entity may comprise or be comprised in at least one of a location management function or a sensing access point. The at least one probing signal may include a sensing signal and/or a position reference signal. The at least one scan measurement may provide information about the area, wherein the at least one scan measurement provides, for each object sensed and/or channel path carrying the at least one probing signal, one or more measurements with respect to one or more of the following: a beamwidth, a beam direction, a range, a time of arrival, an angle of arrival, velocity, a Doppler value, a set of one or more complex coefficients, and a channel estimate for the channel path carrying the at least one probing signal. The at least one scan measurement may include a scan identifier to identify the at least one scan measurement obtained from the at least one probing signal from other scan measurements performed on other probing signals. The first sensing access point may receive the at least one probing signal transmitted by the second sensing access point and perform the at least one scan measurement In response to the sending of the at least one scan measurement to the managing entity, the first sensing access point may receive another request to receive another probing signal to enable an updated scan of at least a portion of the area, and may send at least one other scan measurement to the managing entity to provide information about the updated scan of at least the portion of the area. The first sensing access point and the second sensing access point may comprise or be comprise the same sensing access point.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a process for sensing of the network environment, in accordance with some example embodiments;

FIG. 2 depicts another example of a process for sensing of the network environment, in accordance with some example embodiments;

FIG. 3A depict an example of the sensing process, in accordance with some example embodiments;

FIG. 3B depict another example of the sensing process, in accordance with some example embodiments;

FIG. 4 depicts an example of a network node, in accordance with some example embodiments; and

FIG. 5 depicts an example of an apparatus, in accordance with some example embodiments.

Like labels are used to refer to same or similar items in the drawings.

### DETAILED DESCRIPTION

The 5^{th} generation (5G) of mobile communication may have driven the network to its physical performance bounds with respect to latency, throughput, and spectral efficiency. As the 6^{th} (6G) and beyond evolves, the network may further include aspects of a so-called physical-biological network, in which case a controller may be used to sense the state and behavior of device, objects, and the like within the network's environment. However, a challenge for the next generation may be the sensing capabilities. Moreover, the features or services of the sensing capabilities may need access to the same physical resources, so challenges may arise with respect to sharing the physical resources, scheduling, and determining the quality of service of the sensing capabilities.

In some example embodiments, there is provided aspects related to sensing. In some example embodiments, there is provided a way for the network to sense the environment. In some example embodiments, a gNB type base station or a transmit receive point (e.g., a TRP, at a distributed unit of a disaggregated gNB or other type of device providing a transmit and a receive point for sensing) may (1) transmit at least one signal and (2) receive a least one signal, such that the signals are used to sense the environment (e.g., for objects such as scatterers or other types of objects). For example, at least one gNB may transmit at least one signal, such as at least one signal, which may be received by one or more other gNBs and information measured (or extracted) from the received signals may be aggregated to provide a representation of the environment. For example, the representation may provide information, such as a “picture” (or network tomography) of the objects sensed in the environment. This information may include, for each sensed object, a location of the object, dimensions of the object, a speed of the object, Doppler of the object, and/or other information. Moreover, the objects (e.g., scatterers) being sensed may be passive, such that the objects do not need to actively transmit and/or actively receive the at least one signal in order to sense the objects.

As used herein, the phrase “sensing access point” (SAP) may be used to generally refer to an access point, such as a gNB, a DU, a TRP, a user terminal configured to perform the passive sensing of objects in the environment as disclosed herein, and/or other type of device configured to sense the environment in accordance with some example embodiments. Alternatively, or additionally, the SAP may comprise, or be comprised in, a device that provides the sensing disclosed herein and provides other network functions, such as a gNB, a DU, and/or the like. Alternatively, or additionally, the SAP may comprise, or be comprised in, a device that is dedicated to providing the sensing disclosed herein, without providing other network functions, such as the gNB or DU functions.

With passive sensing in next generation wireless networks such as 6G and beyond, the phrase “passive sensing” refers to the ability of the network to operate as a so-called “radar” to sense (e.g., “detect”) objects in the environment. For example, a first SAP may scan the environment with signals (e.g., probing signals) that can be received by at least one other SAP (and/or the first SAP itself), such that the receiving SAPs sense objects in the environment. In this example, the first SAP and the at least one other SAP are part of the same network, such that the SAPs use the same or similar signaling and procedures to enable the sensing. This probing is passive in the sense that the objects being sensed (e.g., the objects/scatterers located in the environment) do not need to be active devices that receive and process the probing signal as is the case with an active localization service where an active group of devices, such as user equipment (UE), measure the time of arrival (ToA) and/or angle of arrival (AoA) of known positioning reference signals and/or actively transmit signals that then will be received by access points. In next generation wireless networks however, network devices may need to support the noted active localization procedures and the passive sensing operations, in accordance with some example embodiments.

In the case of passive sensing, a first SAP may, as noted, transmit at least one signal, such as a probe signal, that is then measured by at least one receiving SAP to provide information about the sensed objects in the environment. The at least one receiving SAP may be the first SAP itself or other SAPs able to receive the transmitted signal. Alternatively, or additionally, multiple SAP transmitters and multiple SAP receivers may be used to probe the same environment, in which case the use of additional SAP transmitters and/or receivers may provide better resolution, localization accuracy of objects sensed in the environment, shape definition of objects sensed in the environment, object characterization of objects sensed in the environment, and/or range with respect to objects detected in the sensed environment, when compared to using a single SAP at the transmitter and/or receiver.

With respect to using multiple SAP transmitters and/or multiple SAP receivers probing the same environment, the different SAPs may require coordination with respect to procedures and standard signals to enable the collaboration and aggregation of the signal measurements. For example, each SAP (which is tasked to transmit signals such as a probing signal) may need to know one or more of the following in order to transmit the probe signal(s): when to transmit (e.g., in which frame and/or subframe), where to transmit (e.g., directional transmit beamforming information), and what to transmit (e.g., what symbols and on which resource elements including total bandwidth). Likewise, each SAP may also need to know one or more of the following in order to receive and measure the transmitted signals: when (e.g., in which frame and/or subframe), where (e.g., directional transmit beamforming information), and what (e.g., what symbols and on which resource elements including total bandwidth). The receiving SAP(s) may thus be configured to the right time-frequency resources and directions where a transmitted probe signal is present. In this way, each receiving SAP may contribute to the overall sensing service, which as noted may improve the accuracy and/or resolution information about the environment, when compared to using only a single transmit SAP and/or a single receive SAP, for example. In some example embodiments, there is provided a process to allow the aggregation of the information from multiple SAPs.

In some example embodiments, there may be provided distributed passive sensing, which may provide information about objects in the environment be sensed by the SAPs. This information may provide, as noted, information characterizing the environment including the object(s) therein. For example, the information may provide the location of object(s), range of the object(s), shape of the object(s), dimensions of the object(s), height of the object(s), speed of the object(s), Doppler of the object(s), and/or other characteristics of the object(s) sensed in the environment. This information about the object(s) (“object information”) may provide a map, such as a virtual representation of the environment. This map may be in the form of a 2-D or 3-D map or a 2-D or 3-D picture of the object(s) sensed in the environment. The sensing may be considered distributed with respect to the transmission of probe signals and/or reception of probe signals being distributed among multiple SAPs. Moreover, the sensing may be considered passive in the sense that the scatterers do not need to actively transmit and/or actively receive the at least one probing signal in order for the probe signal(s) to characterize a scatterer's location, and the like.

In some example embodiments, there may be provided a managing entity for the sensing processes, in accordance with some example embodiments. In some example embodiments, the managing entity may determine a set of scans needed from each SAP to provide object information, such as the picture of sensed environment. In some example embodiments, the managing entity may determine the quality of the sensing by determining which SAPs and/or how many SAPs are to be used to transmit probing signals (as well as which and/or how many SAPs are to be used to receive the probing signals) in order to provide a virtual representation (e.g., a 2 or 3-D map, picture, view, or other object information) indicative of the current state of the sensed environment including the one or more objects sensed by the SAPs. For example, the managing entity may configure at least one SAP to perform a first scan of an area and then configure at least one SAP to perform a subsequent scan (e.g., using narrower beamwidth) of the area to provide higher resolution object information, when compared to the first scan. The scan may refer to the transmission at least one probing signal by at least one SAP at a given time and/or at the same frequencies.

In some example embodiments, the managing entity may, as noted, determine which of the SAPs should receive and measure a set of scans, and may determine the parameters for receiving the set of scans. For example, at least a first SAP may perform a scan of the environment by transmitting at least one probing signal (e.g., a position reference signal (PRS) transmitted with a given time and frequency allocation on a directional beam), which may be received by one or more SAPs. In this example, the managing entity may determine not only which of the SAPs will transmit the probe signals but which SAPs should receive and measure the probe signals. To illustrate further, the managing entity may determine how many and which SAPs should be used to transmit and/or receive the probing signals in a given area to provide the information about one or more objects sensed by the SAPs.

In some example embodiments, the managing entity may share with each of the SAPs the information needed to perform the determined transmit scans. In some example embodiments, the managing entity may share with each of the SAPs the information needed to receive and measure the sensing scans transmitted. To enable the reception and measurement of the probing signals, the managing entity may provide the parameters of the scan, such as the when, where, and what noted above.

While one or more scans are performed, each SAP (which is successfully configured by a managing entity for example) may receive the scans (e.g., the probing signals) to be measured. For each scan, objects and/or scatterers may generate paths in the RF channel between the transmitting SAP and the receiving SAP. For each scan and path (corresponding to an object/scatterer, for example), a set of information may be determined (e.g., measured and/or the like). The “path” may thus refer to channel paths, detected objects, and/or scatterers. For example, each SAP may measure (e.g., extract, obtain, estimate, ascertain, and/or otherwise determine) information from the scans by for example determining (for each probe signal(s) received from a corresponding transmitting SAP and/or for each object sensed in the environment) a set of information (e.g., a beamwidth, a beam direction, a range, a time of arrival, an angle of arrival, a Doppler value, a set of one or more complex coefficients, and a channel estimate for a path carrying the at least one signal, or other information about one or more objects in the area or a signal path). The set of complex coefficients (which is described further below) refers to so called raw information detected from a received probing signal. Each complex coefficient may refer to the amplitude and/or phase of one frequency, i.e. one subcarrier, of the received signal, such as a probing signal. Alternatively, or additionally, a complex coefficient may refer to a channel state or other channel coefficient providing raw information regarding the received probe signal or the channel that carried the probe signal.

For example, if a first SAP transmits one or more first probing signals and a second SAP transmits one or more second probing signals, the SAP receivers may perform measurements on the first probe signals, and those measurements can be aggregated as a first set of information for each of the objects sensed, while measurements for the second probe signals may be collected and aggregated into a second set of information for each of the objects sensed. In other words, for each scan of an area for example, each object sensed may have a corresponding set of information which can be aggregated to provide information about the area being sensed.

In some example embodiments, the set of information (which may be extracted or measured from the probe signal(s) by each receiving SAP) may be transmitted back to the managing entity. And, this set of information may be provided for each scan received by a given receiving SAP to enable the managing entity to aggregate the information from the SAPs to generate a picture of the environment. In some example embodiments, the set of information for a given scan may identified with a scan ID that identifies a scan and/or a time stamp when the probe signal was received. For example, a scan may comprise the transmission of at least one probing signal by at least one SAP at a given time (e.g., the same time) and/or at the same frequencies. In this example, the scan is identified with a scan ID, such that when the SAPs report (or share) the measurements or other information about the received probing signals the scan ID can be used to identify the scan. As noted, the aggregated information may be used to generate a picture of the environment including a set of observed scatterers, such that each scatterer is identified with for example extracted or measured information (e.g., range information, AoA, ToA, Doppler, a set of complex coefficients, and/or other object information).

In some example embodiments, one or more subsequent scans may be configured based on one or more initial scans. For example, the managing entity may configure an initial set of one or more scans, which may (or may not) identify one or more channel paths, objects, and/or scatterers. In this example, the managing entity may configure one or more SAPs to perform a subsequent, dedicated scan with parameters specific to the newly identified one or more scatterers. This subsequent scan may be of a higher quality of service, so the subsequent scan may focus on the newly identified one or more scatterers in order to improve the picture (e.g., information) of the environment. For example, the specific parameters for the subsequent scan of the new one or more scatterers may include the use of a specific beamwidth, direction for transmission of the probing signal, direction for reception of the probing signals, and/or refined SAP selection (e.g., selecting, based on location, an SAP receiver and/or transmitter to scan the area associated with the newly identified scatterer).

In some example embodiments, the managing entity may comprise, or be comprised in, a location management function (LMF) or other type of node or entity modified to provide the disclosed functionalities. In some example embodiments, the managing entity may comprise, or be comprised in, an SAP.

In some example embodiments, the sensing quality of service may be varied based on a desired quality of the information about the objects in the sensed area. For example, a managing entity may configure the SAPs to perform a first set of one or more scans of an area to be sensed using a lower resolution (e.g., providing 3 meter resolution for objects/scatterers) and/or perform a second set of one or more scans of the area (or a portion of the area) to be sensed using a higher resolution (e.g., providing 1 meter resolution). In this example, the second set of scans may be in response to newly detected one or more scatterers, as noted above, or for other reasons as well. The resolution and accuracy may be controlled, by the managing entity, based on beamwidth (e.g., transmitting the probing signals using a narrower beamwidth in the direction of the newly detected scatterers).

In some example embodiments, the directional information of a scan of the environment may be enhanced by including a desired direction and/or a desired beamwidth, which may allow a trade-off between beam sweep speed and resolution. For example, a set of one or more scans may include probe signals transmitted with narrow beams (e.g., 5 degrees beamwidths which require 24 scans to fully scan a 120 degree area being sensed) or with wider beams (e.g., 15 degrees beamwidths which require 8 beams to scan the same area). This example illustrates a tradeoff to be made by the managing entity with respect to having higher resolution (e.g., ability to discriminate scatterers with more than 5 degrees separation, where wide beams would require 15 degree object separation) and better beamforming gain (which provides greater range). But narrower beams require more time to fully scan a sector as the narrower beams need 24 transmissions instead of 8.

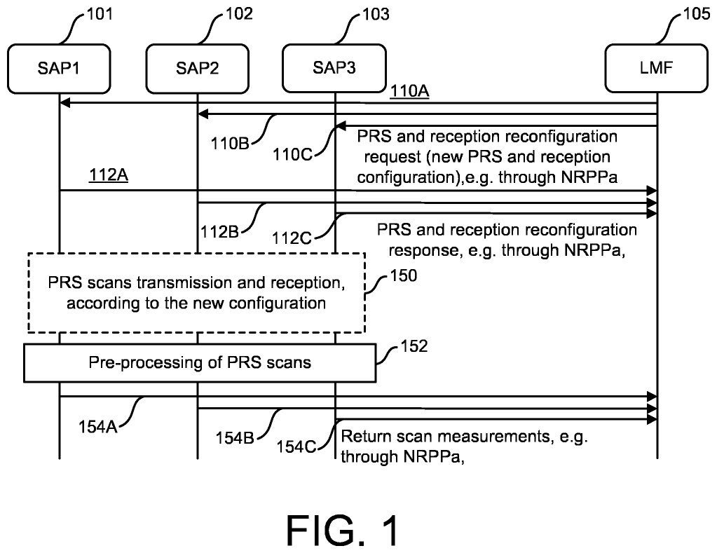

FIG. 1 depicts an example of a process for sensing of the network environment, in accordance with some example embodiments. The process at FIG. 1 depicts a managing entity (which manages the sensing process) comprising or comprised in a network node or entity, which in this example is a location management function (LMF) 105. FIG. 1 also depicts one or more SAPs, such as SAP 101, SAP 102, and SAP 103, although other quantities of SAPs may be implemented as well. Each of the SAPs 101-103 may correspond to an access point, such as a gNB base station, a DU, and/or another device configured to sense objects as disclosed herein.

In the example of FIG. 1, the LMF 105 may manage at least a portion of the transmit and receive of signals, such as probing signal, transmitted and received as scans in order to sense an environment, such as an area. Although some of the examples disclosed herein refer to the signal being transmitted and received by the SAPs as a probing signal, such as a PRS, the probing signal may be other types of signals, such as a sensing signal, a Synchronization Signal Block (SSB), a Channel State Information Reference Signal (CSI-RS), and/or other types of signals which may be used as for the scan(s). For example, the signal may be a predefined or a structured signal, such as a control signal or a user data signal.

At 110A-C, the position reference signal (PRS) and reception request may be provided to the SAPs 101-103, in accordance with some example embodiments. If there is a default PRS transmission and reception pattern configured at an SAP, the request at 110A-C may represent a reconfiguration request of the PRS transmission and reception pattern configuration for the SAP.

In some example embodiments, the requests 110A-C may indicate that at least one SAP is requested to transmit a probing signal (e.g., a PRS) and/or may indicate that at least one SAP is requested to receive a probing signal (e.g., the PRS). Alternatively, or additionally, the requests 110A-C may indicate (or include) probe signal transmission information, such as when to transmit the PRS signal (e.g., in which frame, subframe, offset, or other indication of the resource allocation for the probing signal), where to transmit (e.g., directional transmit beamforming information), and/or what to transmit (e.g., PRS on which resource elements including total bandwidth). For example, the SAP may be provided with a configuration for the PRS transmission that specifies beam direction information, bandwidth, burst size, a period, a start time of the transmission, and/or other information. For example, the bandwidth may correspond to the total aperture in frequency used to transmit the probing signal (to be associated to a subcarrier spacing and hopping), burst size is the number of consecutive symbols and/or subframes on which the probing signal is transmitted, and period is the interval in number of subframes between the transmission of one probing signal and the following one of a single scan The beam direction information may include a direction for a beam (beam direction) carrying the PRS, beamwidth for the beam, and/or a beam index (e.g., in the case of an analog/hybrid beamforming). Alternatively, or additionally, the requests 110A-C may indicate (or include) probe signal receive information, such as the above-noted when, where, and/or what.

With the PRS transmission, it may be transmitted as part of on-going PRS transmission on a downlink by a given SAP towards a UE, in which case the PRS may be received and measured by the SAPs (as well as other intended receivers such as the UE of the downlink). Alternatively, or additionally, the PRS may be carried by a special PRS transmission for purposes of sensing.

In some example embodiments, the requests 110A-C may be exchanged in accordance with a protocol, such as a New Radio (NR) Positioning Protocol A (NRPPa) (see, e.g., 3GPP TS 38.455: NG-RAN; NR Positioning Protocol A (NRPPa)), between the SAP and LMF, although other types of protocols or messages may be used at 110A-C to provide the PRS transmission and reception pattern configured to the SAP.

In some example embodiments, one or more (if not all) of the SAPs 101-103 may be configured as SAP transmitters transmitting a probing signal, such as a PRS. For example, each SAP may have a same probing signal transmission pattern. Alternatively, each SAP may have a different probing signal transmission pattern (e.g., transmission configuration with different parameters with respect to frequency, time, bandwidth, beamwidth, etc.). The use of different transmit configurations may be useful to describe beam sweeps or to allow use of different amounts of resources on different transmit directions depending on the required quality of the sensing.

In some example embodiments, the managing entity provides to the SAPs configuration information for the PRS transmission and/or reception. This configuration information may include directional information. As noted, the beam direction information may include a direction for a beam (beam direction), beamwidth for the beam, and/or a beam index (in the case of analog/hybrid beamforming (if the managing entity has the beam index information). For example, the LMF 105 may indicate, at 110A-C, to one or more SAPs 101-103 a direction for the transmission of the PRS scan and/or a direction for the reception of the PRS scan. In other words, the managing entity (which in this example is LMF 105) suggests one or more directions associated to each PRS scan configuration. This may be useful in the presence of hybrid or analog beamforming, where the receiver should know where the signal is coming from before receiving it in order to correctly apply receive beamforming.

In some embodiments, the managing entity may provide to the SAPs other parameters to assist in the reception of PRS. Examples of these other parameters include expected min-max range of the received signal such as the probing signal, min-max Doppler of the received signal such as the probing signal, min-max azimuth of the received signal such as the probing signal, min-max elevation of the received signal such as the probing signal, and/or other information to enable the SAP to receive the PRS.

At 112A-C, the SAP 101-103 may each accept or reject the PRS configuration with a response to the LMF 105, in accordance with some example embodiments. As noted the configuration may represent a reconfiguration of the PRS transmission pattern, so if the reconfiguration (provided at 110A-C) is not accepted by a given SAP, the LMF may instead share with the other SAPs the default (if any) PRS transmission scheme for the given SAP that did not accept the reconfiguration.

At 150, the SAPs 101-103 may send (e.g., transmit) the PRS and/or measure the received PRS transmitted by the other SAPs, in accordance with some example embodiments. For example, each of the SAPs 101-103 may transmit (and/or receive) the PRS based on the configuration provided with requests 110A-C (which are accepted with the responses at 112A-C). In this example, the receive SAPs 101-103 may receive the other SAPs PRS transmission. Each scan may be received and measured to extract a set of information, such as ToA, AoA, Doppler, a set of complex coefficients, the channel estimation of the RF path of the PRS, processed/pre-processed range, processed/pre-processed velocity, and/or other object information regarding the sensed objects. Moreover, the set of information may be for a specific scan and a specific object/scatterer. And, the set of information may be mapped (or associated with) a scan ID. For a scan of an area for example at a given time, a first SAP transmits one or more first probing signals of the area including an object and a second SAP transmits one or more second probing signals of the area including the object. In this example, each of the SAP receivers may provide, for the scan of the object, a set of information about the object. Moreover, each of the SAP receivers may use the same scan ID to identify that the set of information was obtained using the same scan from the first and second SAPs.

At 152, the SAPs 101-103 may pre-process the received and measured probing signals such as the PRS by for example removing clutter (e.g., static components of the channel for that PRS transmission or objects not of interest) and/or extracting additional information from the pre-processed PRSs. For example, a relatively large object may generate multiple reflections that can be measured by the SAP (so, e.g., paths coming from different angles but similar range). In this example, pre-processing may join or cluster these reflections or paths before reporting to the managing entity. Alternatively, or additionally, the pre-processing may include compressing the extracted (e.g., measured) information for each received PRS scan. For example, multiple tuples of ToA, AoA, Doppler, and/or complex coefficient may be pre-processed to remove, for example, clutter (e.g., static aspects of the area being scanned and/or joining channel paths to form a unique object. To illustrate further, the pre-processing may include compression to remove each n^{th} subcarrier, removal of self-interference or clutter, and/or the like.

At 154A-C, the SAPs 101-103 may share the measurements of the PRS transmission scans with the managing entity, which in this example is the LMF 105, in accordance with some example embodiments. For example, each SAP may provide to the LMF a list of PRS scans received and measured (with each PRS scan mapped to a scan ID and time stamp). Moreover, each of the PRS scans may include measured (e.g., estimated) path information for the scan (e.g., for each object, scatterer, or path, there is a set of information such as ToA, AoA, Doppler, a complex coefficient, and/or other object information. And, if pre-processed some of the information may be compressed or pre-processed in other ways.

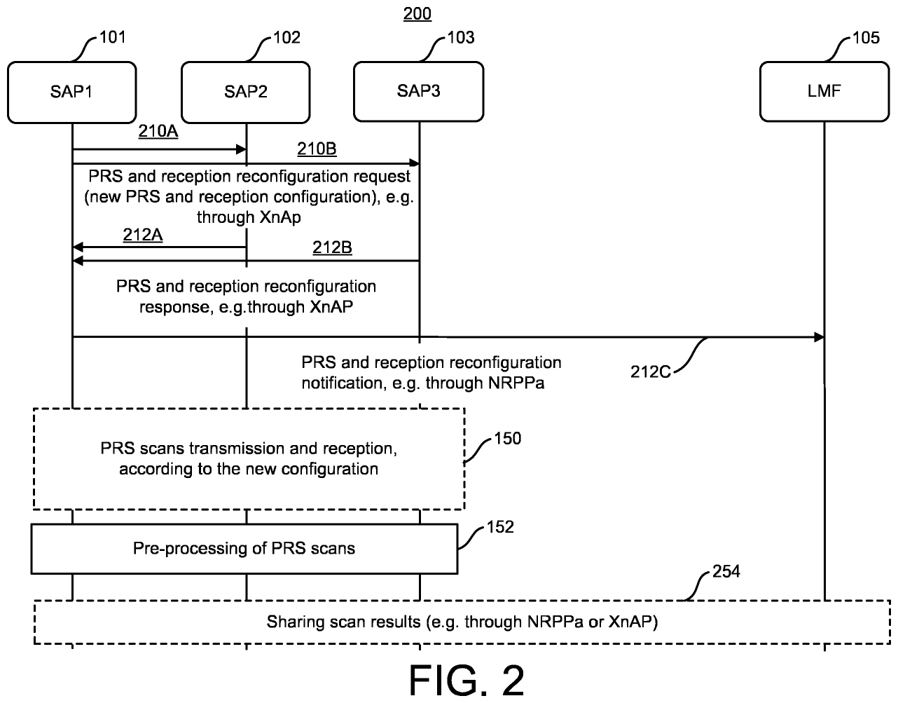

FIG. 2 depicts another example of a process 200 for sensing of the environment, in accordance with some example embodiments. The process of FIG. 2 is somewhat similar in some respects to the process of FIG. 1, but the process of depicts an SAP as a managing entity of the sensing process, rather than the LMF as shown in FIG. 1.

In the example of FIG. 2, the probing signal may comprise user data as the probing signal. For example, the SAP 101 knows the structure of the user data to be sent to its UE(s) which can also be received by the SAPs 102 and 103 as probing signals as the SAP 101 can describe the configuration of the user data probing signal that the SAP 102+103 are to measure.

At 210A-B, the SAP 101 (which in this example serves as the managing entity) may send to SAPs 102-103 a request to configure a probing signal, such as a PRS, in accordance with some example embodiments. The requests 210A-B may be the same or similar to the requests 110A-C described above.

At 212A-B, the SAPs 102-103 may send to SAP 101 (which serves as a managing entity) a response to accept or reject the requests 210A-B, in accordance with some example embodiments. The responses 212A-B may be the same or similar to the responses 112-A-C described above.

At 212C, the SAP 101 (which serves as the managing entity) may send a message to the LMF 105 to indicate which SAPs are participating in the sensing using the probing signals. For example, SAPs 101-103 may all choose to perform the PRS transmission and reception, in which case SAP 101 may indicate at 212C to the LMF 105 that SAPs 101-103 are scanning the environment. Alternatively, or additionally, the SAP 101 may be designated by the LMF 105 as a managing entity for the sensing. Alternatively, or additionally, the LMF 105 may send a request to the SAP 101, and this request may be sent prior to 210A-B to indicate that SAP 101 is (or is requested to be) a managing entity for a given region of the environment.

In some example embodiments, the SAPs 101-103 may proceed with the PRS transmission and reception and process the scans in the same or similar manner as described above with respect to 150-152. Moreover, the scan results may be shared at 254 among the SAPs and LMF via an NRPPa interface (in the case of the LMF) or an Xn interface (in the case of SAPs).

As noted above, the managing entity may request an initial PRS scan of the environment and then request additional scans based on the outcome of the initial PRS scan. In the case of these multi-step scans, the SAPs may be configured with multiple, sequential scans, each of which may have different PRS parameters to obtain information about the sensed environment (e.g., develop the picture of the objects in the environment). As noted, these multiple, sequential scans may be configured based on a prior or an initial PRS scan. For example, a first PRS scan may provide the SAP (or managing entity) with a general sense of the environment. Next, the SAP (or managing entity) may configure or tune the PRS scan parameters based on the results of the first scan. Some of the PRS scan parameters that the SAP (or managing entity) may configure or tune for subsequent scans include one or more of the following: expected AoA of certain PRS transmissions/receptions; expected zenith AoA (ZoA) of certain PRS transmissions/receptions; ZoA beamwidths, angular resolution, timing and bandwidth of the PRS, beam direction information, and/or other information to inform the SAPs. This type of operation can be useful to detect new scatterers that enter an environment as well. For example, a new object may be detected (or believed to be detected) and then the SAP can run one or more subsequent scans on a refined area in order to fully understand how the new object is affecting the environment. These subsequent scans may each be iterative in the sense that the PRS scan parameters may be tuned for each scan to develop a better picture of the new object, for example.

As noted above, the complex coefficients may be used in the sensing, in accordance with some example embodiments, to convey raw information. For example, each complex coefficient may indicate a state of the measured baseband (e.g., received amplitude and phase) of the path of the received PRS probing signal component. The complex coefficient may be different from a carrier phase measurement as the complex coefficient is taken in baseband, and the complex coefficient may also require amplitude information. With the received PRS scans, clutter from walls and/or static objects may be present and may produce reflections that are measured. In this context, having access to each PRS scan's channel path estimate with respect measured amplitude (or power) and (if present) phase (e.g., phase relative to other paths) may facilitate the reconstruction of the environment by allowing estimation of the reflection coefficient (thus, profile and/or material of the scatterer) and allowing coherent processing techniques (e.g., clutter removal, angular interpolation, and the like). The same goes with Doppler (or, e.g., speed) information that can help to discriminate two targets at the same AoA and/or range.

In some example embodiments, the beam directionality information for probing signals, such as PRS, may be extended (e.g., modified) to include configuring different/diverse PRS transmissions having different focus and/or resolution. For example, each of the PRS transmissions and corresponding reception may include directional configuration. This directional information may include azimuth and/or elevation direction. Alternatively, or additionally, the directional information may include azimuth and/or elevation resolution signaled by for example communicating the half power beamwidth (which is the minimum angular difference between the angle providing the maximum beamforming gain and the angle providing half that gain). Alternatively, or additionally, the directional information may include a desired side-lobe relative power compared to the maximum beamforming gain. This may be useful in determining antenna tapering (windowing) coefficients to keep side-lobes under control. This may be performed using weights calculated with Chebyshev or Taylor windows, for example.

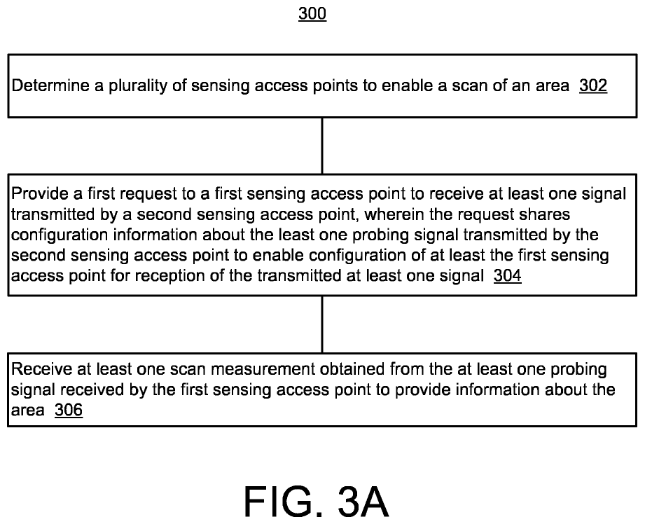

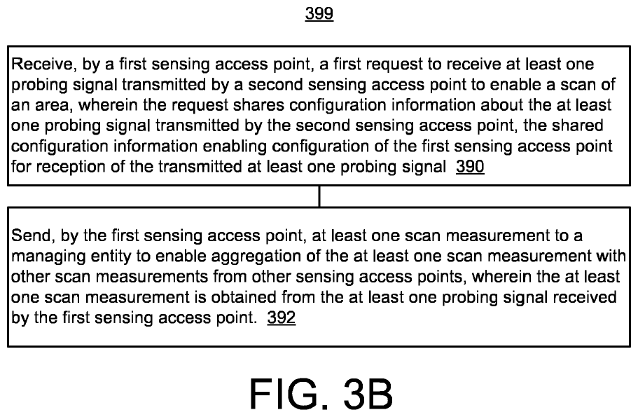

FIG. 3A depicts an example of a process 300 for sharing among SAPs configuration information to enable sensing, in accordance with some example embodiments.

At 302, the managing entity may determine a plurality of sensing access points to enable a scan of an area, in accordance with some example embodiments. For example, a managing entity may comprise or be comprised in an SAP and/or a LMF. The managing entity may determine which SAPs should be used to sense an area. Referring to FIG. 2 the managing entity may determine SAPs 101-103 should be selected for sensing. This selection may take into account the location of the SAPs, capabilities of the SAPs (e.g., whether they support sensing), sensing quality of service (e.g., resolution and/or accuracy of information obtained from the objects sensed in the environment), and/or other factors.

At 304, the managing entity may provide a first request to a first sensing access point to receive at least one probing signal transmitted by a second sensing access point to enable the scan, in accordance with some example embodiments. As noted above with respect to 110A-C and 210A-B, the request may share configuration information for the at least one probing signal transmitted by the second sensing access point to enable configuration of at least the first sensing access point for reception of the transmitted at least one probing signal. For example, the managing entity may provide to the receiving SAP the transmit SAP's configuration information for the at least one probing signal. The configuration information may include one or more of the following: a frame number, a subframe number, transmit beam direction information, a direction, a beamwidth, a beam identifier, one or more resource elements (i.e., OFDM symbols and subcarriers, carrying the at least one probing signal), the probing signal content, either explicitly (data) or as initializers to pre-defined and/or pre-configured sequences (PRS), the probing signal's modulation and coding, a bandwidth, a burst size, a period, and a start time indicating a transmission time of the at least one probing signal. In some example embodiments, the managing entity may determine the configuration information based on a quality of service for the scan of the area with respect to accuracy and/or resolution of the information about the area. The managing entity may also provide a second request to the second sensing access point to transmit the at least one probing signal to enable the scan, and this second request may include configuration information to configure at least the second sensing access point to transmit the at least one probing signal. As noted above, the first access point(s) and the second sensing access point(s) may be the same access points (e.g., the probe signal transmitter is also one of the receivers of the probe signal) and/or may be different sensing access points.

At 306, the managing entity may receive at least one scan measurement obtained from the at least one probing signal received by the first sensing access point to obtain information about an area, in accordance with some example embodiments. The at least one scan measurement may provide information about the area. Furthermore, the managing entity may aggregate the at least one scan measurement with other scan measurements from other sensing access points. Moreover, the at least one scan measurement may include measurements with respect to one or more of the following (for each object/scatterer or channel path): a beamwidth, a beam direction, a range, a time of arrival, an angle of arrival, a Doppler value, a set of one or more complex coefficients, and a channel estimate for a path carrying the at least one probing signal. In some example embodiments, the at least one scan measurement includes a scan identifier to identify the at least one scan measurement obtained from the at least one probing signal from other scan measurements performed on other probing signals. In some example embodiments, the managing entity may provide information about objects sensed in the scanned area. This information may be in the form of a picture, network tomography, or other form.

As noted above, the managing entity may determine the configuration information to enable the scan and then may determine, based at least on the at least one scan measurement, updated configuration information to enable an updated scan of at least a portion of the area.

FIG. 3B depicts an example of a process 399 at an SAP for sensing, in accordance with some example embodiments.

At 390, a first sensing access point may receive a first request to receive at least one probing signal transmitted by a second sensing access point to enable a scan of an area, wherein the request shares configuration information about the at least one probing signal transmitted by the second sensing access point, the shared configuration information enabling configuration of the first sensing access point for reception of the transmitted at least one probing signal. For example, SAP 101 may receive from a managing entity a request as noted above with respect to 110A-C and 210A-B. In the case the first access point and the second access point are the same access point, the first access point may share with itself the configuration information (and/or with other SAPs) to allow the reception.

At 392, the first sensing access point may send at least one scan measurement to a managing entity to enable aggregation of the at least one scan measurement with other scan measurements from other sensing access points, wherein the at least one scan measurement is obtained from the at least one probing signal received by the first sensing access point. For example, the SAP 101 may receive at least one probing signal, such as a PRS, and measure the received probing signal(s). The measurements may then be provided to the managing entity as noted above with respect to 154 and 254.

As noted above, a SAP may be configured to transmit a probing signal and receive a return signal caused by that transmitted probing signal. Alternatively, or additionally, the SAP may receive signals transmitted by other SAPs. In both instances, the SAP may measure the received signals and report the measurements to the managing entity as part of the sensing disclosed herein. For example, the managing entity may share configuration information to enable the SAP to receive the noted return signal and/or the other received signals (transmitted by other SAPs).

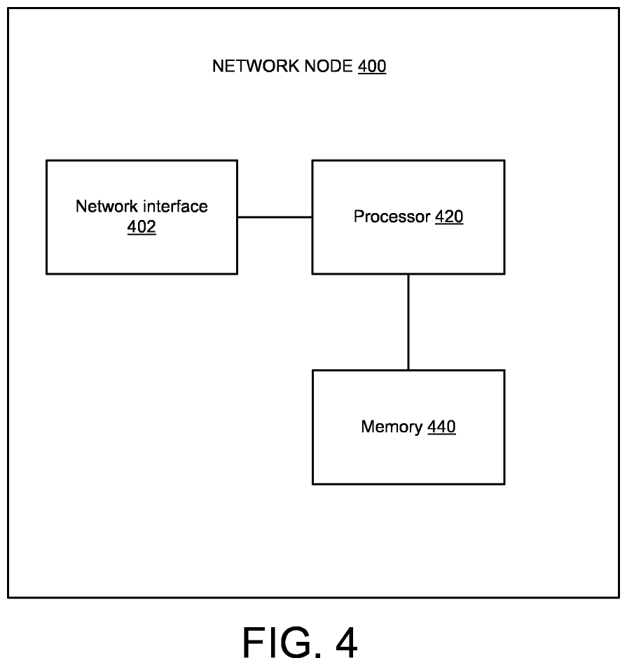

FIG. 4 depicts a block diagram of a network node 400, in accordance with some example embodiments. The network node 400 may comprise or be comprised in one or more network side nodes or functions (e.g., gNB, eNB, DU, TRPs, LMFs, a managing entity, and/or the like).

The network node 400 may include a network interface 402, a processor 420, and a memory 404, in accordance with some example embodiments. The network interface 402 may include wired and/or wireless transceivers to enable access other nodes including base stations, other network nodes, the Internet, other networks, and/or other nodes. The memory 404 may comprise volatile and/or non-volatile memory including program code, which when executed by at least one processor 420 provides, among other things, the processes disclosed herein with respect to the SAPs, LMFs, and managing entities. For example, the network node may be configured to provide process 200, 300 and/or 399.

In some example embodiments, the apparatus 400 may determine a plurality of sensing access points to enable a scan of an area, and provide a first request to a first sensing access point to receive at least one probing signal transmitted by a second sensing access point, wherein the request shares configuration information about the at least one probing signal transmitted by the second sensing access point to enable configuration of at least the first sensing access point for reception of the transmitted at least one probing signal.

In some example embodiments, the apparatus 400 may receive a first request to receive at least one probing signal transmitted by a second sensing access point to enable a scan of an area, wherein the request shares configuration information about the at least one probing signal transmitted by the second sensing access point, the shared configuration information enabling configuration of the apparatus for reception of the transmitted at least one probing signal.

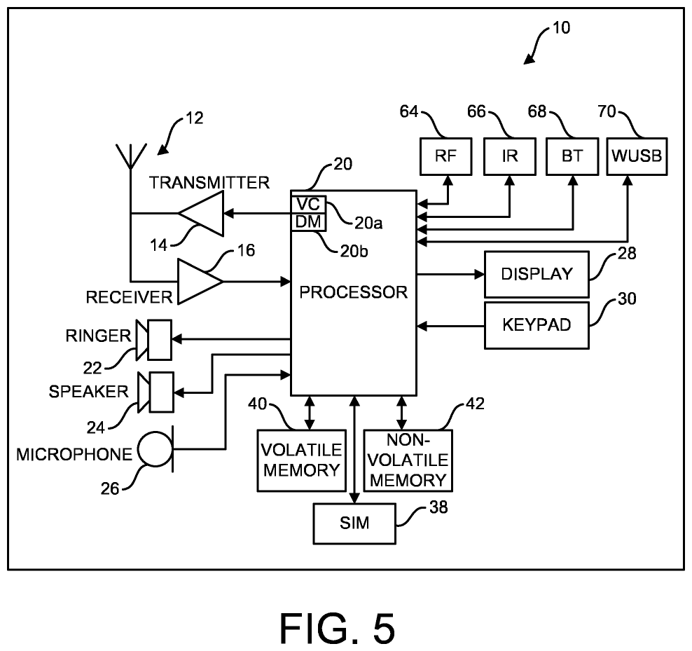

FIG. 5 illustrates a block diagram of an apparatus 10, in accordance with some example embodiments. The apparatus 10 may comprise or be comprised in a user equipment, such as user equipment 204. In general, the various embodiments of the user equipment 204 can include cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions, in addition for vehicles such as autos and/or truck and aerial vehicles such as manned or unmanned aerial vehicle and as well as portable units or terminals that incorporate combinations of such functions. The user equipment may comprise or be comprised in an IoT device, an Industrial IoT (IIoT) device, and/or the like. In the case of an IoT device or IToT device, the UE may be configured to operate with less resources (in terms of for example power, processing speed, memory, and the like) when compared to a smartphone, for example.

In some example embodiments, the apparatus 10 may be configured to provide the functions disclosed herein with respect to the SAPs, LMFs, and managing entities. For example, the apparatus may be configured to provide process 200, 300, and/or 399 to enable sensing.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 5 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, sixth-generation (6G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 5, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, U-SIM, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the UE (e.g., one or more of the processes, calculations, and the like disclosed herein including the process at FIG. 3)

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiments, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may include increased network performance due to better knowledge regarding the network environment including the presences of objects, such as scatterers.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1. A method comprising:
determining, by a managing entity, a plurality of sensing access points to enable a scan of an area; and
providing, by the managing entity, a first request to a first sensing access point to receive at least one probing signal transmitted by a second sensing access point, wherein the request shares configuration information about the at least one probing signal transmitted by the second sensing access point to enable configuration of at least the first sensing access point for reception of the transmitted at least one probing signal.

2. The method of claim 1, further comprising:
receiving, by the managing entity, at least one scan measurement obtained from the at least one probing signal received by the first sensing access point to provide information about the area.

3. The method of claim 1, further comprising:
providing, by the managing entity, a second request to the second sensing access point to transmit the at least one probing signal, wherein the second request includes the configuration information to configure at least the second sensing access point to transmit the at least one probing signal.

4. The method of claim 1, wherein the configuration information includes one or more of the following: a frame number, a subframe number, transmit beam direction information, a direction, a beamwidth, a beam identifier, one or more resource elements carrying the at least one probing signal, a bandwidth, a burst size, a period, and a start time indicating a transmission time of the at least one probing signal.

5-7. (canceled)

8. The method of claim 1, wherein the determining comprises determining at least the first sensing access point to receive the at least one probing signal and determining at least the second sensing access point to transmit the at least one probing signal.

9-14. (canceled)

15. A method comprising:
receiving, by a first sensing access point, a first request to receive at least one probing signal transmitted by a second sensing access point to enable a scan of an area, wherein the request shares configuration information about the at least one probing signal transmitted by the second sensing access point, the shared configuration information enabling configuration of the first sensing access point for reception of the transmitted at least one probing signal.

16. The method of claim 15 further comprising:
sending, by the first sensing access point, at least one scan measurement to a managing entity to provide information about the area to enable aggregation of the at least one scan measurement with other scan measurements from other sensing access points, wherein the at least one scan measurement is obtained from the at least one probing signal received by the first sensing access point.

17. The method of claim 15, wherein the configuration information includes one or more of the following: a frame number, a subframe number, transmit beam direction information, a direction, a beamwidth, a beam identifier, one or more resource elements carrying the at least one probing signal, a bandwidth, a burst size, a period, and a start time indicating a transmission time of the at least one probing signal.

18-19. (canceled)

20. The method of claim 15, wherein the at least one probing signal comprises a sensing signal and/or a position reference signal.

21-25. (canceled)

26. An apparatus comprising:
at least one processor; and
at least one memory including computer program code, the at least one memory and the computer program code configured to, with the at least one processor, cause the apparatus to at least:
determine a plurality of sensing access points to enable a scan of an area; and
provide a first request to a first sensing access point to receive at least one probing signal transmitted by a second sensing access point, wherein the request shares configuration information about the at least one probing signal transmitted by the second sensing access point to enable configuration of at least the first sensing access point for reception of the transmitted at least one probing signal.

27. The apparatus of claim 26, wherein the apparatus is further caused to receive at least one scan measurement obtained from the at least one probing signal received by the first sensing access point to provide information about the area.

28. The apparatus of claim 26, wherein the apparatus is further caused to provide a second request to the second sensing access point to transmit the at least one probing signal, wherein the second request includes the configuration information to configure at least the second sensing access point to transmit the at least one probing signal.

29. The apparatus of claim 26, wherein the configuration information includes one or more of the following: a frame number, a subframe number, transmit beam direction information, a direction, a beamwidth, a beam identifier, one or more resource elements carrying the at least one probing signal, a bandwidth, a burst size, a period, and a start time indicating a transmission time of the at least one probing signal.

30. (canceled)

31. The apparatus of claim 2, wherein the apparatus comprises or is comprised in at least one of a managing entity, a location management function, or a sensing access point.

32-34. (canceled)

35. The apparatus of claim 26, wherein the apparatus determines the configuration information based on a quality of service with respect to accuracy and/or resolution.

36-39. (canceled)

40. An apparatus comprising:
at least one processor; and
at least one memory including computer program code, the at least one memory and the computer program code configured to, with the at least one processor, cause the apparatus to at least:
receive a first request to receive at least one probing signal transmitted by a second sensing access point to enable a scan of an area, wherein the request shares configuration information about the at least one probing signal transmitted by the second sensing access point, the shared configuration information enabling configuration of the apparatus for reception of the transmitted at least one probing signal.

41. The apparatus of claim 40, wherein the apparatus is further caused to send at least one scan measurement to a managing entity to provide information about the area to enable aggregation of the at least one scan measurement with other scan measurements from other sensing access points, wherein the at least one scan measurement is obtained from the at least one probing signal received by the apparatus.

42. The apparatus of claim 40, wherein the configuration information includes one or more of the following: a frame number, a subframe number, transmit beam direction information, a direction, a beamwidth, a beam identifier, one or more resource elements carrying the at least one probing signal, a bandwidth, a burst size, a period, and a start time indicating a transmission time of the at least one probing signal.

43. The apparatus of claim 40, wherein each of the apparatus and the second sensing access point comprise or are comprised in at least one of a base station, a gNB, a distributed unit, a radio unit, or a transmit receive point.

44. (canceled)

45. The apparatus of claim 40, wherein the at least one probing signal comprises a sensing signal and/or a position reference signal.

46-56. (canceled)
